(19) United States
(12) Patent Application Publication
(10) Pub. No.: US 2007/0244641 A1
(43) Pub. Date: Oct. 18, 2007

(54) Active material based haptic communication systems

(75) Inventors: Osman D. Altan, Northville, MI (US); Alan L. Browne, Grosse Pointe, MI (US); Nancy L. Johnson, Northville, MI (US); Brian S. Repa, Beverly Hills, MI (US); Robin Stevenson, Bloomfield, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/734,313

(22) Filed: Apr. 12, 2007

Related U.S. Application Data
(60) Provisional application No. 60/792,481, filed on Apr. 17, 2006.

(51) Int. Cl. G05D 1/00

(52) U.S. Cl. 701/300; 701/2

(57) ABSTRACT

Active material based haptic communication and alert systems are provided. In an embodiment, a haptic alert system comprises: an active material in operative communication with a vehicle surface, the active material being capable of changing at least one attribute in response to an applied activation signal; and a controller in communication with the active material, wherein the controller is configured to selectively apply the activation signal, and wherein the vehicle surface has at least one property that changes with the change in the at least one attribute of the active material.

### CROSS REFERENCE TO RELATED APPLICATIONS

This application relates to and claims the benefit of priority to U.S. Provisional Application No. 60/792,481 filed Apr. 17, 2006, incorporated herein by reference in its entirety.

### BACKGROUND

This disclosure generally relates to haptic alerts, and more particularly, to active material based haptic communication and alert systems for communicating to and alerting a driver and/or passenger of a condition.

Haptic-based alert systems are emerging in the marketplace to provide a signal to the drivers and/or occupants of a vehicle of various conditions that may occur in the forward, side (left and right), and rear directions. For example, vibrotactile devices and displacement devices have been employed to alert a driver of a potential impact event or to warn a driver when the vehicle drifts out of a designated lane. All of these haptic based alert systems utilize mechanical actuators such as electric motors, solenoids, pistons, and the like that act in concert to provide the desired haptic alert. Currently used mechanical actuators are costly, have relatively large form factors, and have higher power consumption. Further, it is not a straightforward process to couple the output of such mechanical actuators to the driver. It is therefore desirable to develop other types of haptic-based alert systems that overcome some of the problems inherent with the use of mechanical actuators.

### BRIEF SUMMARY

Disclosed herein are active material based haptic communication and alert systems. In an embodiment, a haptic alert system comprises: an active material in operative communication with a vehicle surface, the active material being capable of changing at least one attribute in response to an applied activation signal; and a controller in communication with the active material, wherein the controller is configured to selectively apply the activation signal, and wherein the vehicle surface has at least one property that changes with the change in the at least one attribute of the active material.

In an embodiment, a method for alerting an occupant of a vehicle of a condition comprises: detecting the condition and producing an activation signal based on the condition; and applying the activation signal to an active material in operative communication with a vehicle surface to change at least one property of the vehicle surface.

In one embodiment, the vehicle surface comprises a vehicle seat surface divided into sections that correspond to different directions of collision threat detection, wherein each section is capable of moving, vibrating, or pulsing when a collision threat is detected in the direction corresponding to the section.

In another embodiment, the vehicle surface comprises a steering wheel surface in communication with a steering wheel device for applying motion to a steering wheel, wherein the steering wheel device comprises: two discs separated by a driver comprising the active material, wherein the active material changes shape in response to receiving the activation signal; pins extending between the two discs that engage holes in the discs; a first shaft attached to one of the discs and to a steering wheel; and a second shaft attached to the other of the discs and to a steering mechanism for controlling wheel movement.

In yet another embodiment, the vehicle surface comprises a steering wheel surface in communication with a steering wheel device for applying motion to a steering wheel, wherein the steering wheel device comprises: two discs for transferring motion; a first shaft attached to one of the discs and to the steering wheel; a second shaft attached to the other of the discs and to a steering mechanism for controlling wheel movement; complementary interlocking features arranged around a periphery of the two discs such that gaps are formed between the interlocking features and the two discs, and drivers residing in the gaps, the drivers comprising the active material which changes shape in response to receiving the activation signal.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1 is a schematic of the zone (or field of view) coverage for exemplary short range and long range collision avoidance systems which monitor threats in the forward, side and rear directions;

FIG. 2 is a system for providing haptic collision avoidance alerts in accordance with exemplary embodiments;

FIG. 3 illustrates example partitions in a seat cushion that may be utilized to provide haptic collision avoidance alerts in an exemplary embodiment;

FIG. 4 illustrates a block diagram of an active material based haptic communication system in accordance with one embodiment;

FIG. 5 illustrates a steering wheel device that utilizes an active material to generate tactile vibrations/sensations in a steering wheel in accordance with one embodiment; and

FIG. 6 illustrates a steering wheel device that utilizes an active material to generate tactile vibrations/sensations in a steering wheel in accordance with another embodiment.

### DESCRIPTION OF THE PREFERRED EMBODIMENT

Exemplary embodiments provide integrated haptic collision alerts that supply timely information to a driver of a vehicle about the presence, urgency, and direction of various conditions. Alternative embodiments include active material enabled haptic-based communications for providing other information to a driver such as alerting/awakening the driver of/from his drowsiness, alerting of excessive distraction from the driving function due to excessive workload (for example vibration intensity increase as workload factors such as cell phone use increase), alerting of the need to turn headlights on and/or the turn signal off, alerting of the presence of a vehicle in one's blind spot for example when one activates the turn signal or starts to turn the wheel for a lane change, altering the driver to low fuel levels, and the like.

The systems described herein utilize active materials to provide the haptic-based communication/alert. The use of active materials overcomes many of the disadvantages associated with the currently used mechanical-based actuators. Through the field activated change in the property of the active material in response to a signal from a controller, information such as the need for some specific action can be communicated to the driver/occupant. The signal can be based, for example, on a change in a sensor input (e.g., received from a radar sensor for detecting whether there is adequate separation between the subject vehicle and the vehicle in front, a lane tracking sensor to ensure that a vehicle is following lane markings, and a driver eye motion sensor to ensure that the driver is not falling asleep), information from a map, a GPS, a WiFi, or other database or electronic telecommunication system, or passively in response to a naturally occurring change in the environment such as a change in temperature. The signal could also be based on customer preference settings to which the controller is linked. For example, when adjustable settings match those preferred by the occupant/user, the interface (e.g., seat or steering wheel) can be textured, pulsed, vibrated, etc. to indicate correspondence. Additionally, the signal could also be based on the detected state of the current vehicle or another vehicle such as door ajar, seat belt not engaged, fuel door open, mechanical/repair issues of an urgent nature such as low tire pressure or low oil level. Vehicle readiness sensors can be utilized to detect such vehicle conditions. The interface can change in response to the detected vehicle state. For example, a child safety lock button could become textured when activated and smooth when deactivated. For these and similar features, active material based haptic alerts can serve as a reinforcement to visual and/or auditory signals, or as a means of drawing the users attention to visual signals that might otherwise be missed due to excessive workload.

For certain active materials, the magnitude of the change in the property is proportional to the magnitude of the applied field. Thus, in the case of at least some of the active materials, through differences in the magnitude and/or rate of application of the applied field, the urgency for or nature of the specific action that needs to be taken or the urgency for or nature of the specific information that is being communicated can be communicated to the driver through differences in the magnitude and quickness of the change in the property of the active material. Changes in the frequency of activation and in the amount of material activated could also serve this role. Additionally, changes in the location of the material that is activated could be used to communicate the direction to which the driver's occupants' attention should be directed. It is understood that various types of information can be communicated through haptic alerts using a variety of interfaces and a variety of senses for that communication. Examples are in connection with alerting/awakening the driver of/from his drowsiness, alerting of excessive distraction from the driving function due to excessive workload (for example, vibration intensity increase as workload factors such as cell phone use increase), alerting of the need to turn headlights on and/or the turn signal off, and alerting of the presence of a vehicle in one's blind spot for example when one activates the turn signal or starts to turn the wheel for a lane change.

The term “active material” (also called “smart material”) as used herein refers to several different classes of materials all of which exhibit a change in at least one attribute such as shear strength, stiffness, dimension, geometry, shape, and/or flexural modulus when subjected to at least one of many different types of applied activation signals. Examples of such signals include, but are not limited to, thermal, electrical, magnetic, stress, and the like. One class of active materials is shape memory materials. These materials exhibit a shape memory. Specifically, after being deformed pseudoplastically, they can be restored to their original shape by the application of the appropriate field. In this manner, shape memory materials can change to a determined shape in response to an activation signal. Suitable shape memory materials include, without limitation, shape memory alloys (SMA), ferromagnetic SMAs (FSMA), and shape memory polymers (SMP). A second class of active materials can be considered as those that exhibit a change in at least one attribute when subjected to an applied field but revert back to their original state upon removal of the applied field. Active materials in this category include, but are not limited to, piezoelectric materials, electroactive polymers (EAP), two-way trained shape memory alloys, magnetorheological fluids and elastomers (MR), electrorheological fluids (ER), composites of one or more of the foregoing materials with non-active materials, combinations comprising at least one of the foregoing materials, and the like. Depending on the particular active material, the activation signal can take the form of, without limitation, an electric current, a temperature change, a magnetic field, a mechanical loading or stressing, or the like. Of the above noted materials, SMA and SMP based assemblies preferably include a return mechanism to restore the original geometry of the assembly. The return mechanism can be mechanical, pneumatic, hydraulic, pyrotechnic, or based on one of the aforementioned smart materials.

Through the field activated change in the property of the active material in response to a sensor detect of a possible threat, the driver and/or occupants of the vehicle can be alerted to the presence of a condition and as a consequence take appropriate action (or be informed of a condition, if the haptic based alert is so designed). Furthermore, for certain active materials the magnitude of the change in material property is proportional to the magnitude of the applied field. Thus, in the case of at least some of the active materials, through differences in the magnitude and/or rate of application of the applied field, the imminence and/or severity of the detected threat can be communicated to the driver and/or occupants through differences in the size and quickness of the change in the property of the active material. Changes in the frequency of activation and in the amount of material activated could also serve this role. Additionally, changes in the location of the material that is activated could be used to communicate the direction of the threat.

The active material based haptic alert systems are more robust than strictly electromechanical approaches as they have no mechanical parts since it is the active material itself that transmits the haptic alert. The active material devices also, in almost all cases, emit neither acoustic nor electromagnetic noise or interference. Because of their small volume, low power requirements, and distributed actuation capability among other attributes, they can be embedded into the vehicle surface/components at various locations (or any other vehicle component as may be desired) and give feedback to the driver by, for example, vibration (time varying displacement/stiffness) of varying magnitudes and frequencies. For example, they can also be located in specific locations in the seat, the steering wheel, pedals, and the like, and actuated in a certain sequence or just in select locations to convey additional feedback to the driver, for example, as to direction of the condition. Expanding on this, activation of just a section on the left side of the seat, for example, could indicate detection of a condition from the left direction. Alternatively, activation in a certain sequence such as a “wave” moving from left to right across the seat could be another means of indicating the direction in which the threat is approaching. It is comprehended that differences in the frequency and/or amplitude of vibration could also be used to indicate the severity of the threat (impending collision). Changes in the frequency and/or amplitude of vibration with time could also be used to indicate a change in the probability or imminence of a threat from cautionary up through truly imminent. It is also comprehended that the use of active materials as haptic feedback devices has potentially wide application. Indeed, these devices can be used in conjunction with various sensor based convenience and safety systems such as park assist, collision warning, adaptive cruise control, lane departure warning, inattentive driver sensing system, drowsy driver sensing system, and the like. Another advantage of using active materials for haptic feedback is that the level of warning given to the driver can be adjusted very easily by a simple controller. It is comprehended that this would permit personalization of, for example, magnitude, frequency, and location (in the seat) of the haptic feedback. It also would allow retuning/resetting of levels (again principally frequencies, amplitudes) with age and use of the active material based haptic device. Table 1 illustrates various interfaces and of the ways in which the various field activated changes in active material properties can be used as haptic means of communication.

TABLE 1

| FEET | FACE, HANDS |
|---|---|
| Accelerator Pedal (force feedback) | Blowing air |
| Brake Pedal | |
| Floorboard | |
| BACK, BOTTOM, HEAD | TORSO |
| Seat and Headrest: vibration, | Seat belt: vibration, stiffness change |
| stiffness change, temperature | |
| change | |
| HANDS | EYES/VISUAL |
| Steering wheel: stiffness change, | Mirrors: chromogenic change, image |
| shape change, vibration, voltage, | distortion, time variations |
| turning force | |
| | Heads-up Display: chromogenic color |
| | change, intensity change, image size |
| | change, time variations |
| EARS/AUDITORY | NOSE/OLFACTORY |
| Steering wheel: clicking | Blowing air with noxious |
| Tone generation (e.g., | smell or odor. |
| piezoelectric) | |

Suitable active materials for providing the actuation of the haptic based alert systems include: shape memory alloys (“SMAs”; e.g., thermal and stress activated shape memory alloys and magnetic shape memory alloys (MSMA)), electroactive polymers (EAPs) such as dielectric elastomers, ionic polymer metal composites (IPMC), piezoelectric materials (e.g., polymers, ceramics), and shape memory polymers (SMPs), shape memory ceramics (SMCs), baroplastics, magnetorheological (MR) materials (e.g., fluids and elastomers), electrorheological (ER) materials (e.g., fluids, and elastomers), electrostrictives, magnetostrictives, composites of the foregoing active materials with non-active materials, systems comprising at least one of the foregoing active materials, and combinations comprising at least one of the foregoing active materials. For convenience and by way of example, reference herein will be made to shape memory alloys and shape memory polymers. The shape memory ceramics, baroplastics, and the like, can be employed in a similar manner. For example, with baroplastic materials, a pressure induced mixing of nanophase domains of high and low glass transition temperature (Tg) components effects the shape change. Baroplastics can be processed at relatively low temperatures repeatedly without degradation. SMCs are similar to SMAs but can tolerate much higher operating temperatures than can other shape-memory materials. An example of a SMC is a piezoelectric material.

The ability of shape memory materials to return to their original shape upon the application or removal of external stimuli has led to their use in actuators to apply force resulting in desired motion. Active material actuators offer the potential for a reduction in actuator size, weight, volume, cost, noise and an increase in robustness in comparison with traditional electromechanical and hydraulic means of actuation. Ferromagnetic SMA's, for example, exhibit rapid dimensional changes of up to several percent in response to (and proportional to the strength of) an applied magnetic field. However, these changes are one-way changes and use the application of either a biasing force or a field reversal to return the ferromagnetic SMA to its starting configuration.

Shape memory alloys are alloy compositions with at least two different temperature-dependent phases or polarity. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is often called the austenite finish temperature (A_{f}). When the shape memory alloy is in the austenite phase and is cooled, it begins to change into the martensite phase, and the temperature at which this phenomenon starts is often referred to as the martensite start temperature (Mₛ). The temperature at which austenite finishes transforming to martensite is often called the martensite finish temperature (M_{f}). The range between Aₛ and A_{f} is often referred to as the martensite-to-austenite transformation temperature range while that between Mₛ and M_{f} is often called the austenite-to-martensite transformation temperature range. It should be noted that the above-mentioned transition temperatures are functions of the stress experienced by the SMA sample. Generally, these temperatures increase with increasing stress. In view of the foregoing properties, deformation of the shape memory alloy is preferably at or below the austenite start temperature (at or below Aₛ). Subsequent heating above the austenite start temperature causes the deformed shape memory material sample to begin to revert back to its original (nonstressed) permanent shape until completion at the austenite finish temperature. Thus, a suitable activation input or signal for use with shape memory alloys is a thermal activation signal having a magnitude that is sufficient to cause transformations between the martensite and austenite phases.

The temperature at which the shape memory alloy remembers its high temperature form (i.e., its original, nonstressed shape) when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery over a wider temperature range. The start or finish of the transformation can be controlled to within several degrees depending on the desired application and alloy composition. The mechanical properties of the shape memory alloy vary greatly over the temperature range spanning their transformation, typically providing shape memory effect and superelastic effect. For example, in the martensite phase a lower elastic modulus than in the austenite phase is observed. Shape memory alloys in the martensite phase can undergo large deformations by realigning the crystal structure arrangement with the applied stress. The material will retain this shape after the stress is removed. In other words, stress induced phase changes in SMA are two-way by nature, application of sufficient stress when an SMA is in its austenitic phase will cause it to change to its lower modulus Martensitic phase. Removal of the applied stress will cause the SMA to switch back to its Austenitic phase, and in so doing, recovering its starting shape and higher modulus.

Exemplary shape memory alloy materials include, but are not limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, combinations comprising at least one of the foregoing alloys, and so forth. The alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range of the intended application.

The recovery to the austenite phase at a higher temperature is accompanied by very large (compared to that needed to deform the material) stresses, which can be as high as the inherent yield strength of the austenite material, sometimes up to three or more times that of the deformed martensite phase. For applications that require a large number of operating cycles, a strain of less than or equal to about 4% or of the deformed length of wire used can be obtained.

MSMAs are alloys; often composed of Ni—Mn—Ga, that change shape due to strain induced by a magnetic field. MSMAs have internal variants with different magnetic and crystallographic orientations. In a magnetic field, the proportions of these variants change, resulting in an overall shape change of the material. An MSMA actuator generally requires that the MSMA material be placed between coils of an electromagnet. Electric current running through the coil induces a magnetic field through the MSMA material, causing a change in shape.

As previously mentioned, other exemplary shape memory materials are shape memory polymers (SMPs). “Shape memory polymer” generally refers to a polymeric material, which exhibits a change in a property, such as a modulus, a dimension, a coefficient of thermal expansion, the permeability to moisture, an optical property (e.g., transmissivity), or a combination comprising at least one of the foregoing properties in combination with a change in its a microstructure and/or morphology upon application of an activation signal. Shape memory polymers can be thermoresponsive (i.e., the change in the property is caused by a thermal activation signal delivered either directly via heat supply or removal, or indirectly via a vibration of a frequency that is appropriate to excite high amplitude vibrations at the molecular level which lead to internal generation of heat), photoresponsive (i.e., the change in the property is caused by an electromagnetic radiation activation signal), moisture-responsive (i.e., the change in the property is caused by a liquid activation signal such as humidity, water vapor, or water), chemo-responsive (i.e. responsive to a change in the concentration of one or more chemical species in its environment; e.g., the concentration of H⁺ ion—the pH of the environment), or a combination comprising at least one of the foregoing.

Generally, SMPs are phase segregated co-polymers comprising at least two different units, which can be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment can be (semi-)crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n−1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, “predetermined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it can be possible to demonstrate multiple permanent shapes. Similarly using a layered or composite approach, a combination of multiple SMPs can demonstrate transitions between multiple temporary and permanent shapes.

SMPs exhibit a dramatic drop in modulus when heated above the glass transition temperature of that of their constituents that has a lower glass transition temperature. Because this is a thermally activated property change, these materials are not well suited for rapid or vibratory haptic communication. If loading/deformation is maintained while the temperature is dropped, the deformed shape can be set in the SMP until it is reheated while under no load to return to its as-molded original shape.

The active material can also comprise a piezoelectric material. Also, in certain embodiments, the piezoelectric material can be configured as an actuator for providing rapid deployment. As used herein, the term “piezoelectric” is used to describe a material that mechanically deforms (changes shape) when a voltage potential is applied, or conversely, generates an electrical charge when mechanically deformed. Piezoelectrics exhibit a small change in dimensions when subjected to the applied voltage, with the response being proportional to the strength of the applied field and being quite fast (capable of easily reaching the thousand hertz range). Because their dimensional change is small (e.g., less than 0.1%), to dramatically increase the magnitude of dimensional change they are usually used in the form of piezo ceramic unimorph and bi-morph flat patch actuators which are constructed so as to bow into a concave or convex shape upon application of a relatively small voltage. The morphing/bowing of such patches within the seat is suitable for vibratory-tactile input to the driver.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion. Unimorphs can exhibit a strain of as high as about 10%, but generally can only sustain low loads relative to the overall dimensions of the unimorph structure.

In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Exemplary piezoelectric materials include inorganic compounds, organic compounds, and metals. With regard to organic materials, all of the polymeric materials with noncentrosymmetric structure and large dipole moment group(s) on the main chain or on the side-chain, or on both chains within the molecules, can be used as candidates for the piezoelectric film. Examples of suitable polymers include, but are not limited to, poly(sodium 4-styrenesulfonate) (“PSS”), poly S-119 (Poly(vinylamine) backbone azo chromophore), and their derivatives; polyfluorocarbines, including polyvinylidene fluoride (“PVDF”), its co-polymer vinylidene fluoride (“VDF”), trifluorethylene (TrFE), and their derivatives; polychlorocarbons, including poly(vinylchloride) (“PVC”), polyvinylidene chloride (“PVC2”), and their derivatives; polyacrylonitriles (“PAN”) and their derivatives; polycarboxylic acids, including poly (methacrylic acid (“PMA”), and their derivatives; polyureas and their derivatives; polyurethanes (“PUE”) and their derivatives; bio-polymer molecules such as poly-L-lactic acids and their derivatives, and membrane proteins, as well as phosphate bio-molecules; polyanilines and their derivatives, and all of the derivatives of tetraamines; polyimides, including Kapton® molecules and polyetherimide (“PEI”), and their derivatives; all of the membrane polymers; poly (N-vinyl pyrrolidone) (“PVP”) homopolymer and its derivatives and random PVP-co-vinyl acetate (“PVAc”) copolymers; all of the aromatic polymers with dipole moment groups in the main-chain or side-chains, or in both the main-chain and the side-chains; and combinations comprising at least one of the foregoing.

Further piezoelectric materials can include Pt, Pd, Ni, T, Cr, Fe, Ag, Au, Cu, and metal alloys comprising at least one of the foregoing, as well as combinations comprising at least one of the foregoing. These piezoelectric materials can also include, for example, metal oxides such as SiO₂, Al₂O₃, ZrO₂, TiO₂, SrTiO₃, PbTiO₃, BaTiO₃, FeO₃, Fe₃O₄, ZnO, and combinations comprising at least one of the foregoing; and Group VIA and IIB compounds such as CdSe, CdS, GaAs, AgCaSe₂, ZnSe, GaP, InP, ZnS, and combinations comprising at least one of the foregoing.

MR fluids is a class of smart materials whose rheological properties can rapidly change upon application of a magnetic field (e.g., property changes of several hundred percent can be effected within a couple of milliseconds. MR fluids exhibit a shear strength which is proportional to the magnitude of an applied magnetic field, wherein property changes of several hundred percent can be effected within a couple of milliseconds. Thus, MR fluids are quite suitable in locking in (constraining) or allowing the relaxation of shapes/deformations through a significant change in their shear strength, such changes being usefully employed with grasping and release of objects in embodiments described herein. Exemplary shape memory materials also comprise magnetorheological (MR) and ER polymers. MR polymers are suspensions of micrometer-sized, magnetically polarizable particles (e.g., ferromagnetic or paramagnetic particles as described below) in a polymer (e.g., a thermoset elastic polymer or rubber). Exemplary polymer matrices include, but are not limited to, poly-alpha-olefins, natural rubber, silicone, polybutadiene, polyethylene, polyisoprene, and combinations comprising at least one of the foregoing.

The stiffness and potentially the shape of the polymer structure are attained by changing the shear and compression/tension moduli by varying the strength of the applied magnetic field. The MR polymers typically develop their structure when exposed to a magnetic field in as little as a few milliseconds, with the stiffness and shape changes being proportional to the strength of the applied field. Discontinuing the exposure of the MR polymers to the magnetic field reverses the process and the elastomer returns to its lower modulus state. Packaging of the coils for generating the applied field, however, creates challenges.

Suitable MR fluid materials include ferromagnetic or paramagnetic particles dispersed in a carrier, e.g., in an amount of about 5.0 volume percent (vol %) to about 50 vol % based upon a total volume of MR composition. Suitable particles include, but are not limited to, iron; iron oxides (including Fe₂O₃ and Fe₃O₄); iron nitride; iron carbide; carbonyl iron; nickel; cobalt; chromium dioxide; and combinations comprising at least one of the foregoing; e.g., nickel alloys; cobalt alloys; iron alloys such as stainless steel, silicon steel, as well as others including aluminum, silicon, cobalt, nickel, vanadium, molybdenum, chromium, tungsten, manganese and/or copper.

The particle size can be selected so that the particles exhibit multiple magnetic domain characteristics when subjected to a magnetic field. Particle diameters (e.g., as measured along a major axis of the particle) can be less than or equal to about 1,000 micrometers (μm) (e.g., about 0.1 micrometer to about 1,000 micrometers), specifically about 0.5 to about 500 micrometers, or more specifically about 10 to about 100 micrometers.

The viscosity of the carrier can be less than or equal to about 100,000 centipoise (cPs) (e.g., about 1 cPs to about 100,000 cPs), specifically, about 250 cPs to about 10,000 cPs, or more specifically about 500 cPs to about 1,000 cPs. Possible carriers (e.g., carrier fluids) include organic liquids, especially non-polar organic liquids. Examples of suitable organic liquids include, but are not limited to, oils (e.g., silicon oils, mineral oils, paraffin oils, white oils, hydraulic oils, transformer oils, and synthetic hydrocarbon oils (e.g., unsaturated and/or saturated)); halogenated organic liquids (such as chlorinated hydrocarbons, halogenated paraffins, perfluorinated polyethers and fluorinated hydrocarbons); diesters; polyoxyalkylenes; silicones (e.g., fluorinated silicones); cyanoalkyl siloxanes; glycols; and combinations comprising at least one of the foregoing carriers.

Aqueous carriers can also be used, especially those comprising hydrophilic mineral clays such as bentonite or hectorite. The aqueous carrier can comprise water or water comprising a polar, water-miscible organic solvent (e.g., methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like), as well as combinations comprising at least one of the foregoing carriers. The amount of polar organic solvent in the carrier can be less than or equal to about 5.0 vol % (e.g., about 0.1 vol % to about 5.0 vol %), based upon a total volume of the MR fluid or more specifically about 1.0 vol % to about 3.0%. The pH of the aqueous carrier can be less than or equal to about 13 (e.g., about 5.0 to about 13) or more specifically about 8.0 to about 9.0.

When the aqueous carriers comprises natural and/or synthetic bentonite and/or hectorite, the amount of clay (bentonite and/or hectorite) in the MR fluid can be less than or equal to about 10 percent by weight (wt %) based upon a total weight of the MR fluid, specifically about 0.1 wt % to about 8.0 wt %, more specifically about 1.0 wt % to about 6.0 wt %, or even more specifically about 2.0 wt % to about 6.0 wt %.

Optional components in the MR fluid include clays (e.g., organoclays), carboxylate soaps, dispersants, corrosion inhibitors, lubricants, anti-wear additives, antioxidants, thixotropic agents, and/or suspension agents. Examples of carboxylate soaps include, but are not limited to, ferrous oleate; ferrous naphthenate; ferrous stearate; aluminum di- and tri-stearate; lithium stearate; calcium stearate; zinc stearate; and/or sodium stearate; surfactants (such as sulfonates, phosphate esters, stearic acid, glycerol monooleate, sorbitan sesquioleate, laurates, fatty acids, fatty alcohols, fluoroaliphatic polymeric esters); coupling agents (such as titanate, aluminate, and zirconate); and combinations comprising at least one of the foregoing. Polyalkylene diols, such as polyethylene glycol, and partially esterified polyols can also be included.

Electrorheological fluids (ER) are similar to MR fluids in that they exhibit a change in shear strength when subjected to an applied field, in this case a voltage rather than a magnetic field. Response is quick and proportional to the strength of the applied field. It is, however, an order of magnitude less than that of MR fluids and several thousand volts are typically required.

Electronic electroactive polymers (EAPs) are a laminate of a pair of electrodes with an intermediate layer of low elastic modulus dielectric material. Applying a potential between the electrodes squeezes the intermediate layer causing it to expand in plane. They exhibit a response proportional to the applied field and can be actuated at high frequencies. EAP patch vibrators have been demonstrated and are suitable for providing the haptic-based alert such as for use in the seat for vibratory input to the driver and/or occupants.

Electroactive polymers include those polymeric materials that exhibit piezoelectric, pyroelectric, or electrostrictive properties in response to electrical or mechanical fields. An example of an electroactive polymer is an electrostrictive-grafted elastomer with a piezoelectric poly(vinylidene fluoride-trifluoro-ethylene) copolymer. This combination has the ability to produce a varied amount of ferroelectric-electrostrictive molecular composite systems.

Materials suitable for use as an electroactive polymer may include any substantially insulating polymer and/or rubber that deforms in response to an electrostatic force or whose deformation results in a change in electric field. Exemplary materials suitable for use as a pre-strained polymer include, but are not limited to, silicone elastomers, acrylic elastomers, polyurethanes, thermoplastic elastomers, copolymers comprising PVDF, pressure-sensitive adhesives, fluoroelastomers, polymers comprising silicone and acrylic moieties (e.g., copolymers comprising silicone and acrylic moieties, polymer blends comprising a silicone elastomer and an acrylic elastomer, and so forth), and combinations comprising at least one of the foregoing polymers.

Materials used as an electroactive polymer can be selected based on desired material propert(ies) such as a high electrical breakdown strength, a low modulus of elasticity (e.g., for large or small deformations), a high dielectric constant, and so forth. In one embodiment, the polymer can be selected such that is has an elastic modulus of less than or equal to about 100 MPa. In another embodiment, the polymer can be selected such that is has a maximum actuation pressure of about 0.05 megapascals (MPa) to about 10 MPa, or more specifically about 0.3 MPa to about 3 MPa. In another embodiment, the polymer can be selected such that is has a dielectric constant of about 2 to about 20, or more specifically about 2.5 and to about 12. The present disclosure is not intended to be limited to these ranges. Ideally, materials with a higher dielectric constant than the ranges given above would be desirable if the materials had both a high dielectric constant and a high dielectric strength. In many cases, electroactive polymers can be fabricated and implemented as thin films, e.g., having a thickness of less than or equal to about 50 micrometers.

Electroactive polymers can deflect at high strains, and electrodes attached to the polymers can also deflect without compromising mechanical or electrical performance. Generally, electrodes suitable for use can be of any shape and material provided that they are able to supply a suitable voltage to, or receive a suitable voltage from, an electroactive polymer. The voltage can be either constant or varying over time. In one embodiment, the electrodes adhere to a surface of the polymer. Electrodes adhering to the polymer can be compliant and conform to the changing shape of the polymer. The electrodes can be only applied to a portion of an electroactive polymer and define an active area according to their geometry. Various types of electrodes include structured electrodes comprising metal traces and charge distribution layers, textured electrodes comprising varying out of plane dimensions, conductive greases (such as carbon greases and silver greases), colloidal suspensions, high aspect ratio conductive materials (such as carbon fibrils and carbon nanotubes, and mixtures of ionically conductive materials), as well as combinations comprising at least one of the foregoing.

Exemplary electrode materials can include, but are not limited to, graphite, carbon black, colloidal suspensions, metals (including silver and gold), filled gels and polymers (e.g., silver filled and carbon filled gels and polymers), ionically or electronically conductive polymers, and combinations comprising at least one of the foregoing. It is understood that certain electrode materials can work well with particular polymers but not as well with others. By way of example, carbon fibrils work well with acrylic elastomer polymers while not as well with silicone polymers.

Electrostrictives are dielectrics that produce a relatively slight change of shape or mechanical deformation under the application of an electric field. Reversal of the electric field does not reverse the direction of the deformation. When an electric field is applied to an electrostrictive, it develops polarization(s). It then deforms, with the strain being proportional to the square of the polarization.

Magnetostrictives are solids that develop a large mechanical deformation when subjected to an external magnetic field. This magnetostriction phenomenon is attributed to the rotations of small magnetic domains in the materials, which are randomly oriented when the material is not exposed to a magnetic field. The shape change is largest in ferromagnetic or ferromagnetic solids (e.g., Terfenol-D). These materials possess a very fast response capability, with the strain proportional to the strength of the applied magnetic field, and they return to their starting dimension upon removal of the field. However, these materials have maximum strains of about 0.1 to about 0.2 percent.

In the exemplary embodiment described herein, vibration alerts in the seat pan of the driver's seat cushion are utilized to inform the driver of the presence, urgency, and direction of potential collision threats. However, as previously discussed, various types of information can be communicated through haptic alerts using a variety of interfaces and a variety of senses for that communication. For example, active material based haptic alerts can be used in connection with alerting/awakening the driver of/from his drowsiness, alerting of excessive distraction from the driving function due to excessive workload (for example vibration intensity increase as workload factors such as cell phone use increase), alerting of the need to turn headlights on and/or the turn signal off, alerting of the presence of a vehicle in one's blind spot, for example, when one activates the turn signal or starts to turn the wheel for a lane change, low fuel levels, and the like.

Illustrative approaches are described below in which the seat vibration activity is mapped to the direction and urgency of a collision threat (and by implication, these approaches also indicate the presence of the collision threat). It will be appreciated that the exemplary approaches described herein can easily be extended to accommodate any current and future collision mitigation/avoidance system. In addition, it should be noted that the seat vibration alert approach may be combined with other warning sensory modalities (e.g., auditory, visual, haptic/tactile).

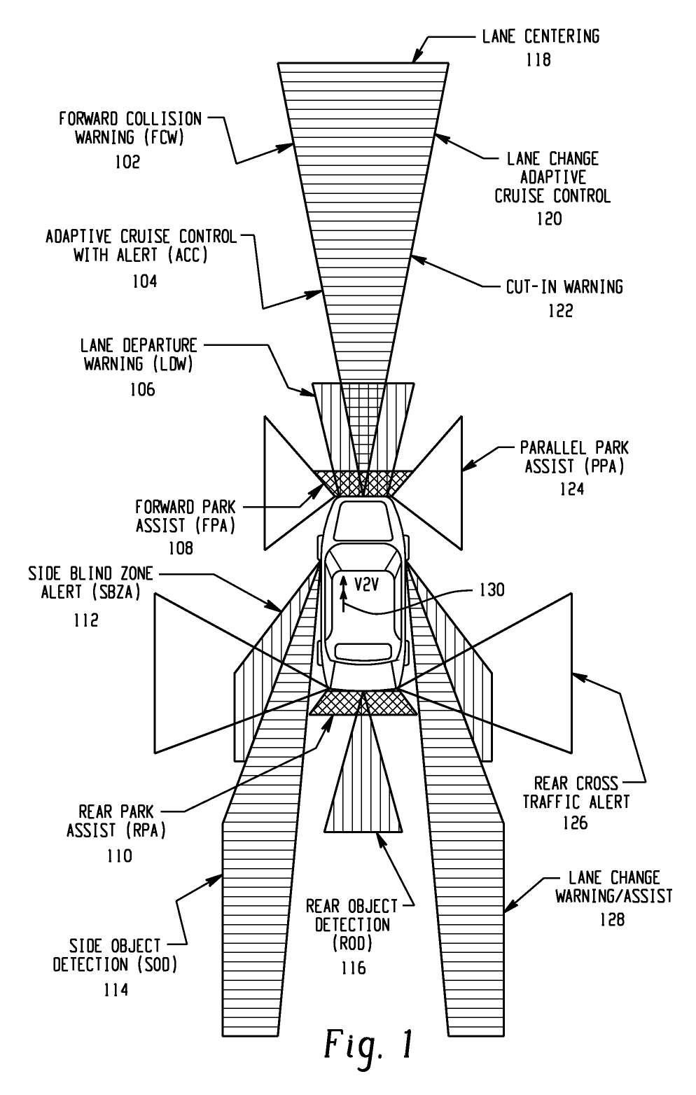

Referring herein to FIG. 1, a schematic example of the zone (or field-of-view) coverage for collision avoidance systems is provided. Examples of such systems include Forward Collision Warning (FCW) 102, Adaptive Cruise Control (ACC) 104, Lane Departure Warning (LDW) 106, Forward Park Assist (FPA) 108, Rear Park Assist (RPA) 110 (includes corner clipping warning while parallel parking), Side Blind Zone Alert (SBZA) 112 (also referred to as a “blind spot system”), (longer range) Side Object Detection (SOD) 114 (also referred to as a “lane change alert system”), (longer range) Rear Object Detection (ROD) 116 (also referred to as a “backing warning system”), Lane Centering 118, Lane Change Adaptive Cruise System 120, Cut-in Warning 122, Rear Cross Traffic Alert 124, and Lane Change Warning/Assist 126. Please note that these zones are not drawn to scale, and are intended for illustrative purposes only.

For the driver of a vehicle equipped with multiple collision mitigation/avoidance systems (such as those shown in FIG. 1) that are monitoring different directions of collision threats, collision alerts should be presented in a manner that allows the driver to quickly and accurately assess the direction and urgency of a collision threat. This will facilitate the ability of the driver to respond to the collision threat in a timely, effective, and appropriate manner to help in avoiding the collision, or in mitigating the impact of the collision. Appropriate driver responses to the collision alert may include braking, accelerating, and/or steering, or simply making no response in the case of a false alarm.

In the present example, there are three sensory modalities that can potentially be utilized to provide collision alerts to drivers in a timely and effective manner: visual, auditory, and haptic. Haptic alerts refer to any warning that is presented through the proprioceptive (or kinesthetic) senses, such as brake pulse deceleration/vehicle jerk, steering wheel vibration/pushback, or accelerator pedal vibration/pushback cues. Seat vibration alerts, a particular example of a haptic alerts, provide a robust method of warning drivers of the presence, direction, and urgency of a potential collision threat. Haptic alerts can also serve as a reinforcement to visual and/or auditory alerts, for example, by drawing the attention of the user to visual signals that might otherwise be missed due to excessive workload. Relative to visual collision alerts, haptic alerts, such as seat vibration alerts, offer the advantage that the driver does not need to be looking in any particular direction (e.g., toward the visual alert) in order to detect and respond appropriately to the collision alert. In this sense, similar to auditory collision alerts, haptic alerts, such as seat vibration alerts, can be viewed as essentially “omni-directional” in nature.

Relative to auditory collision alerts, haptic alerts, such as seat vibration alerts, can be more effective at indicating to the driver the direction of the collision threat. Variations in factors, such as the number and position of speakers, existence of rear speakers, occupant seat/eye/ear positioning, interior ambient noise, cabin architecture and materials, and objects and passengers inside the vehicle, suggest the tremendous complexities involved in presenting collision alert sounds in a manner that would allow the driver to quickly and accurately identify the collision threat direction from auditory collision alerts. In addition, relative to auditory collision alerts, haptic alerts, such as seat vibration alerts, are likely to be perceived as less annoying to drivers (and passengers) during false alarms since they do not interrupt ongoing audio entertainment. Note, that this assumes that collision avoidance systems will temporarily mute or at least reduce audio volume when auditory collision alerts are presented. Furthermore, unlike auditory collision alerts, seat vibration collision alerts would allow the driver to experience the collision alert “privately” (or discretely) without the disturbance of other passengers.

Relative to auditory and visual collision alerts, haptic collision alerts (of which seat vibration cues is one example) may be under-utilized from a driver workload (or attention capacity) perspective, since it can be argued that drivers receive most of their information while driving via the visual and auditory modalities. In addition, relative to auditory and visual collision alerts, the implementation of haptic alerts (e.g., seat vibration alerts) appears to be less sensitive to vehicle-to-vehicle differences. These differences include the number and position of speakers (or speaker layout), existence of rear speakers, occupant positioning (including ear, eye, and head positioning), interior and exterior ambient noise, cabin architecture and materials, objects and passengers inside the vehicle, and the ability of the vehicle architecture to accommodate visual collision alert displays at various locations. Further, haptic alerts appear to be less sensitive to within-driver and driver-to-driver variability than auditory and visual collision alerts. This variability includes changes in occupant positioning (including ear, eye, and head positioning) within and across driving trips, and differences in drivers' modality sensitivity/impairment.

Hence, the use of haptic collision alerts, such as seat vibration collision alerts, increases the ability of a driver to properly use and intuitively understand multiple collision avoidance systems within their vehicle (as well as across vehicles), increases the collision avoidance/mitigation benefits afforded by these systems, and decreases the cost of these systems (in light of the robustness and lack of complexity advantages suggested above). The use of haptic alerts also allows automobile manufacturers to “pick and choose” any subset of available collision avoidance systems without compromising (via system interactions) the collision avoidance benefits afforded by these systems. More generally, utilizing haptic collision alerts, such as seat vibration collision alerts, may increase the deployment and effectiveness of collision avoidance systems.

An exemplary embodiment utilizes seat vibration as a haptic collision alert to indicate to the driver of a vehicle the presence, direction, and urgency of a collision threat in a vehicle equipped with multiple collision avoidance (or warning) systems as illustrated in FIG. 1. The driver experiences seat vibration collision alerts, or cues, through the seat cushion (bottom, or seat pan) portion of the driver's seat (e.g., via a matrix of vibrating elements embedded in the seat cushion), that is, where the driver's buttocks and back of their thighs contact the seat. In an alternate exemplary embodiment, other parts of the vehicle that a driver has direct contact with (e.g., the back of the seat, seatbelts, steering wheel, accelerator, brakes) are vibrated to warn of a potential collision. These examples are intended to be illustrative only, and should not be interpreted as boundaries for this scope of disclosure. Also note that the urgency of the collision threat in each of these examples may be manipulated in a straightforward manner (e.g., by changing the rate at which the seat is vibrated, the length of the vibration, or the intensity of the vibration).

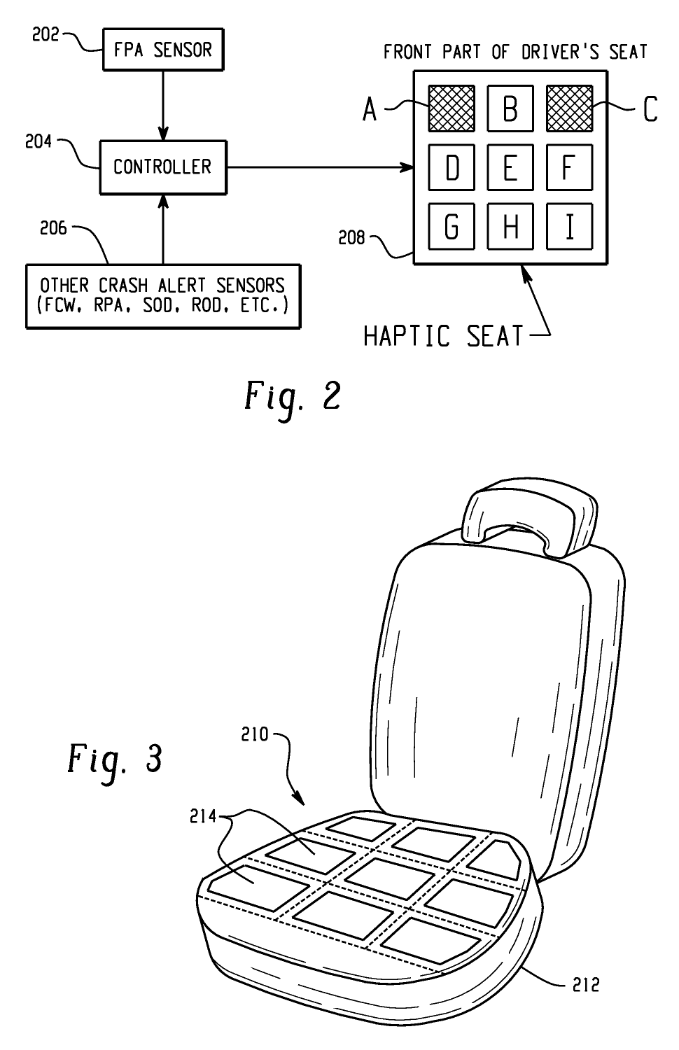

FIG. 2 is a system diagram for providing haptic collision avoidance alerts in accordance with the exemplary embodiments. In the example depicted in FIG. 2, a forward park assist (FPA) sensor 202 is in communication with a controller 204. The FPA sensor 202 communicates to the controller 204 information about the location of objects ahead relative to the driver's vehicle. The controller 204 continuously evaluates information received from the FPA sensor 202 to determine if an object is closer than a selected threshold and hence, if the object poses a collision threat to the vehicle. If the collision alert algorithm located on the controller 204 determines that the driver should be warned of a collision threat, a haptic seat vibration warning is provided in the appropriate location(s) of a haptic seat 208. Also as shown in FIG. 2, data from other collision alert sensors 206 may also be input to the controller 204. In this manner, the sensor data from multiple collision avoidance systems may be collected by the controller 204 and utilized by the controller 204 to determine what haptic alerts to communicate to the driver of the vehicle. In the example shown in FIG. 2, the haptic alerts are provided to the driver via vibrations in matrix locations “A” and “C” on the driver's seat cushion in response to a collision threat being located in front of the vehicle.

Any haptic method of communicating to the driver, as known in the art, may be implemented by exemplary embodiments of the present invention. For example, locations in the seat may pulse and/or change stiffness instead of vibrating. The vibrating and pulsing may occur at different speeds and/or intensities to indicate the urgency of the collision alert. Pulsing or vibrating could be accomplished through many devices, such as seat inflation bladders, or other vibration devices. In addition, other portions of the vehicle may be utilized to provide haptic alerts to the driver of the vehicle. Examples include but are not limited to the back of the seat, the accelerator, the seat belt, the brake pedal, the floor, an arm rest, a head rest, the console, the steering wheel, or a combination comprising at least one of the foregoing vehicle surfaces. Occupants of the vehicle may be provided with the haptic alerts (e.g., driving school vehicles equipped to alert instructors of collision threats). Combinations of various haptic methods and vehicle locations utilized to provide alerts may be implemented by exemplary embodiments of the present invention.

In an exemplary embodiment, the area of the seat cushion that is vibrated is spatially mapped to the corresponding direction of the collision threat, as indicated below:

| Direction of Collision Threat | General Area |
|---|---|
| (Degrees offset from driver using 0° | of Seat Cushion |
| as straight ahead reference point) | That is Vibrated |
| Forward-Straight Ahead (0°) | Front (A, C) |
| Forward-Left Side (−45°) | Front-Left (A) |
| Forward-Right Side (+45°) | Front-Right (C) |
| Side-Left of Vehicle (−90°) | Left Side-Center (D) |
| Side-Right of Vehicle (+90°) | Right Side-Center (F) |
| Rearward-Straight Back (180°) | Rear-Center (H) |
| Rearward-Left Side (−135°) | Rear-Left (G) |
| Rearward-Right Side (+135°) | Rear-Right (I) |

In this example, seat vibration collision alerts corresponding to the four cardinal and four oblique directions in the haptic seat 208 are represented. The letters in parenthesis represent the partition, or matrix, locations as labeled in the haptic seat 208 illustrated in FIG. 2. A picture of a seat pan portion 210 of a seat cushion 212 with the partition locations marked is depicted in FIG. 3. Within each section an active material actuator can be disposed in operative communication with seat surface to provide seat vibrotactile sensation to the seat occupant. For example, a piezoelectric patch 214 can be disposed within the seat cushion and in close proximity to the seat surface.

An alternative exemplary embodiment is similar to the previously discussed embodiment, with the exception that the directional seat vibration collision alert (as defined in the above table) is preceded by an initial “master” seat vibration collision alert which will occur in the center portion of the seat. The purpose of this master collision alert is to first notify the driver of the presence of a collision threat, to provide a frame of reference for which the subsequent directional seat vibration collision alert can be perceived, and to create the perception of apparent motion toward the direction of the collision threat. This added frame of reference may allow the driver to more quickly and effectively identify the direction of the collision threat.

As described above, the embodiments described herein may be embodied in the form of computer-implemented processes and apparatuses for practicing those processes. Embodiments may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment can also be embodied in the form of computer program code, for example, whether stored in a storage medium, loaded into and/or executed by a computer, or transmitted over some transmission medium, such as over electrical wiring or cable, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

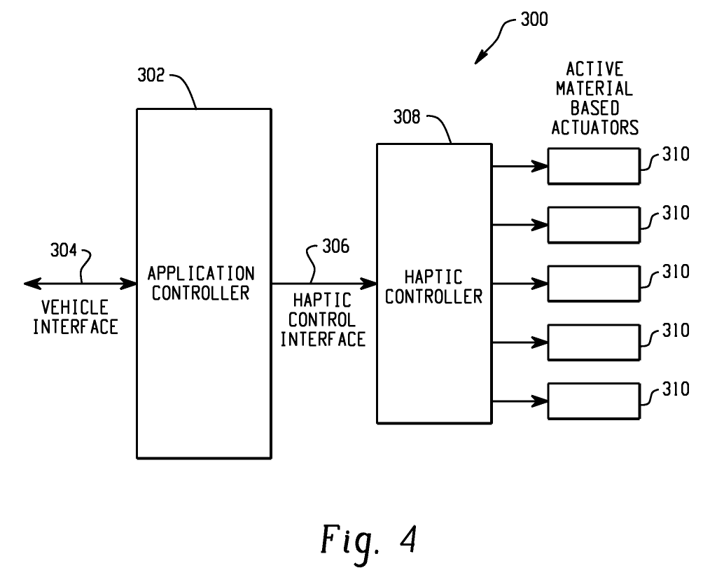

FIG. 4 schematically illustrates a block diagram of an exemplary active material based haptic alert system 300. The system 300 includes application controller 302 having an interface 304 with the vehicle. The application controller 302 can be configured to provide a variety of alert applications, such as but not limited to, collision avoidance, parking assist, lane departure warning, fatigued driver warning, adaptive cruise control, and the like. The application controller 302 provides a signal via a haptic control interface 306 to a haptic controller 308 so as to activate the active material by activating one or more active material based actuators 310 in operative communication with the desired vehicle surface, e.g., vehicle seat.

Another exemplary embodiment utilizes steering wheel vibration as a haptic collision alert to indicate to the driver of a vehicle the presence, direction, and urgency of a collision threat in a vehicle equipped with multiple collision avoidance (or warning) systems as illustrated in FIG. 1. The driver experiences collision alerts, or cues, through the steering wheel where the driver's hands contact the steering wheel. For example, the steering wheel can be configured to shake in a manner analogous to the “stick shaker” employed in aircraft to alert the pilot to an impending stall. Drivers are familiar with the ‘rumble strips’ built into the breakdown lanes of limited-access highways and are conditioned to interpret the noise and vibration generated as a warning signal. Thus, the vibration of the steering wheel also could be in the form of a synthetic rumble strip sensation, which would immediately convey to the driver that an unsafe or potentially unsafe condition exists and alert him to the need for corrective action.

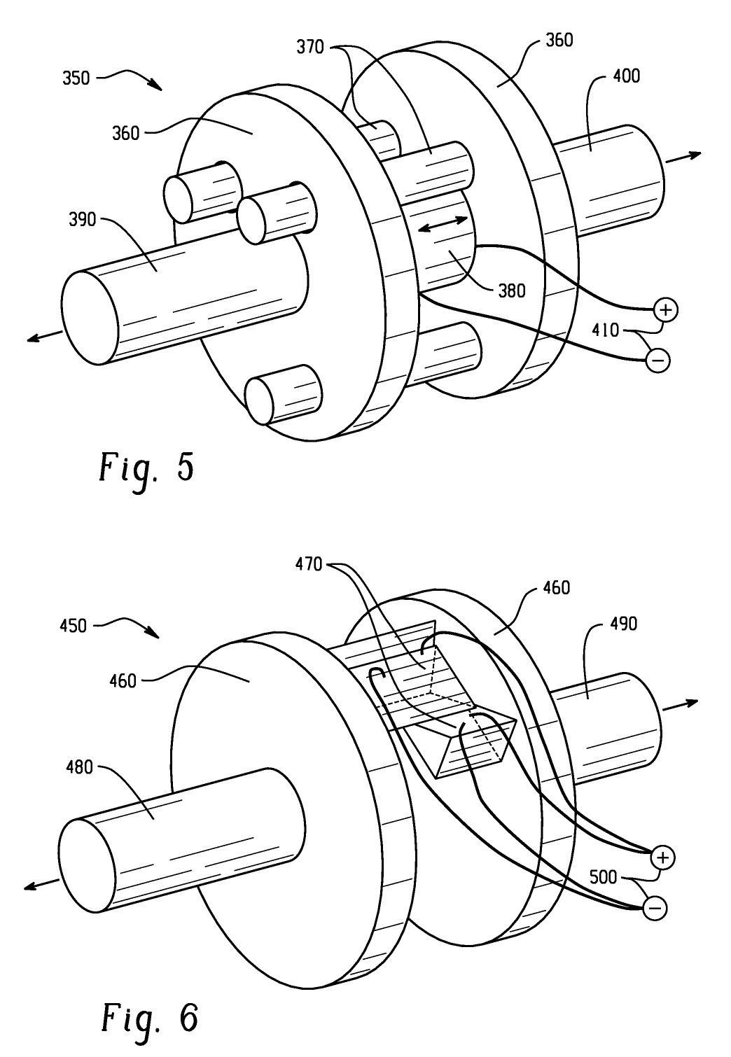

Such steering wheel vibrations/sensations can be achieved by employing an active material described herein in the steering wheel, which changes its length in response to an activation signal. FIG. 5 illustrates an exemplary steering wheel device 350 that utilizes an active material to generate the tactile vibrations/sensations. The steering wheel device 350 includes two discs 360 for transferring motion that are separated by a driver 380 comprising an active material. Integral pins 370 extend between discs 360 and engage holes therein. A first shaft 390 attached to one of the discs 360 is also attached to the steering wheel itself (not shown), whereas a second shaft 400 attached to the other of the discs 360 is attached to a steering mechanism for controlling wheel movement. Positive and negative electrical connections 410 are connected to the steering wheel device 350. By locating a ‘smart material’ driver 380 capable of extension and/or contraction between the discs, a cyclic longitudinal motion can be applied to the steering wheel. Since relatively small displacements at relatively low frequencies are desired, a piezoelectric active material would be suitable for use in driver 380.

FIG. 6 employs a similar concept to impart a cyclic rotational motion to the steering wheel. The design of steering wheel device 450 is similar to an ‘Oldham’ shaft coupling design for accommodating shaft misalignment. The steering wheel device 450 includes two discs 460 for transferring motion. A first shaft 480 is attached to one of the discs 460 and to the steering wheel itself (not shown), whereas a second shaft 490 is attached to the other of the discs 460 and to a steering mechanism for controlling steering (not shown). The steering wheel device 450 comprises complementary interlocking features 470 (shown as triangular prisms) arranged around the periphery of the two discs 460 with gaps between the two such that at least two ‘smart material’ drivers may be sized to fill the gaps. In one embodiment, the drivers could be arranged to operate in complementary fashion so that positive and negative displacements about a mean position could be generated. As shown in FIG. 6, positive and negative electrical connections 500 are connected to the steering wheel device 450.

In yet another embodiment, the concepts shown in FIGS. 5 and 6 could be combined to enable simultaneous rotational and vertical oscillation if desired.

Although specific reference has been made to vibration of seats and steering wheels, other haptic alert systems utilizing active materials include varying pedal resistance, massaging functions, stiffening/tensioning/vibrating the seat belt, and the like.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A haptic communication system, comprising:
an active material in operative communication with a vehicle surface, the active material being capable of changing at least one attribute in response to an applied activation signal; and
a controller in communication with the active material, wherein the controller is configured to selectively apply the activation signal, and wherein the vehicle surface has at least one property that changes with the change in the at least one attribute of the active material.

2. The system of claim 1, wherein the active material comprises a shape memory alloy, an electroactive polymer, an ionic polymer metal composite, a piezoelectric material, a shape memory polymer, a shape memory ceramic, a baroplastic, a magnetorheological material, an electrorheological material, an electrostrictive material, a magnetostrictive material, a composite of at least one of the foregoing active materials with a non-active material, and a combination comprising at least one of the foregoing active materials.

3. The system of claim 1, wherein the controller is in communication with a forward collision warning sensor, an adaptive cruise control sensor, a lane departure warning sensor, a forward park assist sensor, a rear park assist sensor, a side blind zone alert sensor, a side object detection sensor, a rear object detection sensor, a lane centering sensor, a lane change adaptive cruise sensor, a cut-in warning sensor, a rear cross traffic alert sensor, a lane change warning sensor, a vehicle sensor for detecting a state of the vehicle or of another vehicle, or a combination comprising at least one of the foregoing sensors.

4. The system of claim 1, wherein the activation signal is based on a change in sensor input, a customer preference setting, information in a database, an environmental change, a change in a state of the vehicle or of another vehicle, or a combination comprising at least one of the foregoing.

5. The system of claim 1, wherein the vehicle surface is capable of moving, vibrating, changing stiffness, or pulsing with the change in the at least one attribute of the active material.

6. The system of claim 1, wherein the vehicle surface comprises a surface of a seat, a head rest, an accelerator, a brake pedal, a steering wheel, a floor, a seat belt, an arm rest, a console, and a combination comprising at least one of the foregoing.

7. The system of claim 1, wherein the vehicle surface is in communication with an occupant of the vehicle when the vehicle is in operation.

8. The system of claim 1, wherein the vehicle surface comprises a vehicle seat surface divided into sections that correspond to different directions of collision threat detection, and wherein each section is capable of moving, vibrating, changing stiffness, or pulsing when a collision threat is detected in the direction corresponding to the section.

9. The system of claim 1, wherein the vehicle surface comprises a steering wheel surface in communication with a steering wheel device for applying motion to a steering wheel.

10. The system of claim 9, wherein the steering wheel device comprises:
two discs separated by a driver comprising the active material, the active material being capable of extension and contraction;
pins extending between the two discs that engage holes in the discs;
a first shaft attached to one of the discs and to a steering wheel; and
a second shaft attached to the other of the discs and to a steering mechanism for controlling wheel movement.

11. The system of claim 10, wherein the steering wheel device is capable of applying longitudinal motion to the steering wheel.

12. The system of claim 9, wherein the steering wheel device comprises:
two discs for transferring motion;
a first shaft attached to one of the discs and to the steering wheel;
a second shaft attached to the other of the discs and to a steering mechanism for controlling wheel movement;
complementary interlocking features arranged around a periphery of the two discs such that gaps are formed between the interlocking features and the two discs, and
drivers residing in the gaps, the drivers comprising the active material.

13. The system of claim 12, wherein the steering wheel device is capable of applying rotational motion to the steering wheel.

14. A method for alerting an occupant of a vehicle of a condition, comprising:
detecting the condition and producing an activation signal based on the condition; and
applying the activation signal to an active material in operative communication with a vehicle surface to change at least one property of the vehicle surface.

15. The method of claim 14, wherein the activation signal comprises a thermal activation signal, a magnetic activation signal, an electric activation signal, a chemical activation signal, or a combination comprising at least one of the foregoing activation signals.

16. The method of claim 14, wherein the active material comprises a shape memory alloy, an electroactive polymer, an ionic polymer metal composite, a piezoelectric material, a shape memory polymer, a shape memory ceramic, a baroplastic, a magnetorheological material, an electrorheological material, an electrostrictive material, a magnetostrictive material, a composite of at least one of the foregoing active materials with a non-active material, and a combination comprising at least one of the foregoing active materials.

17. The method of claim 14, wherein the condition is detected by a forward collision warning sensor, an adaptive cruise control sensor, a lane departure warning sensor, a forward park assist sensor, a rear park assist sensor, a side blind zone alert sensor, a side object detection sensor, a rear object detection sensor, a lane centering sensor, a lane change adaptive cruise sensor, a cut-in warning sensor, a rear cross traffic alert sensor, a lane change warning sensor, a vehicle sensor for detecting a state of the vehicle or of another vehicle, or a combination comprising at least one of the foregoing sensors.

18. The method of claim 14, wherein the condition comprises a safety hazard, an approach of another object, a state of the vehicle or of another vehicle, a customer preference setting being achieved, information in a database, an environmental condition, or a combination comprising at least one of the foregoing.

19. The method of claim 14, wherein said applying the activation signal to the active material causes motion, vibration, changes in stiffness, or pulsing to occur at the vehicle surface.

20. The method of claim 14, wherein the vehicle surface comprises a vehicle seat surface.

21. The method of claim 14, wherein the vehicle surface comprises a vehicle seat surface divided into sections that correspond to different directions of collision threat detection, and wherein each section moves, vibrates, changes stiffness, or pulses when a collision threat is detected in the direction corresponding to the section.

22. The method of claim 14, wherein the vehicle surface comprises a steering wheel surface.

23. The method of claim 14, wherein the vehicle surface comprises a steering wheel surface in communication with a steering wheel device for applying motion to a steering wheel.

24. The method of claim 23, wherein the steering wheel device comprises:
two discs separated by a driver comprising the active material, wherein the active material changes shape in response to receiving the activation signal;
pins extending between the two discs that engage holes in the discs;
a first shaft attached to one of the discs and to a steering wheel; and
a second shaft attached to the other of the discs and to a steering mechanism for controlling wheel movement.

25. The method of claim 24, wherein the steering wheel device applies longitudinal motion to the steering wheel when the active material extends or contracts.

26. The method of claim 23, wherein the steering wheel device comprises:
two discs for transferring motion;
a first shaft attached to one of the discs and to the steering wheel;
a second shaft attached to the other of the discs and to a steering mechanism for controlling wheel movement;
complementary interlocking features arranged around a periphery of the two discs such that gaps are formed between the interlocking features and the two discs, and
drivers residing in the gaps, the drivers comprising the active material which changes shape in response to receiving the activation signal.

27. The method of claim 26, wherein the steering wheel device applies rotational motion to the steering wheel when the active material changes shape.
